(19) United States
(12) Patent Application Publication
(10) Pub. No.: US 2022/0283540 A1
(43) Pub. Date: Sep. 8, 2022

(54) VOLUME BRAGG GRATING IN A CYLINDRICAL BULK MEDIUM

(71) Applicant: TERAXION INC., Quebec (CA)

(72) Inventors: François TREPANIER, Quebec (CA); Sylvain BOUDREAU, Quebec (CA); Alain MAILLOUX, Quebec (CA); Guillaume BROCHU, Quebec (CA)

(21) Appl. No.: 17/689,645

(22) Filed: Mar. 8, 2022

Related U.S. Application Data
(60) Provisional application No. 63/200,452, filed on Mar. 8, 2021.

(51) Int. Cl. G03H 1/04; G03H 1/02; G02B 5/32

(52) U.S. Cl. CPC G03H 1/0402; G03H 1/0248; G02B 5/32; G03H 2001/0439; G03H 2223/23; G03H 2222/33; G03H 2227/05; G03H 2001/043

(57) ABSTRACT

A method of manufacturing a Volume Bragg Grating (VBG) is provided, comprising providing a cylindrical bulk medium made of a transparent glass material and having a central axis along a longitudinal direction, and inscribing an interference pattern in the cylindrical bulk medium. The interference pattern has a plurality of grating fringe elements distributed along a line parallel to the central axis. The method further includes rotating the cylindrical bulk medium about the central axis during said inscribing, thereby azimuthally extending the grating fringes elements. There is further provided a VBG manufactured according to such a method, the use of such a VBG in a CPA system of cladding-pumped fiber laser.

### CROSS REFERENCE TO RELATED APPLICATIONS

This application claims priority to and the benefit of U.S. Provisional Patent Application No. 63/200,452, filed on Mar. 8, 2021, the disclosure of which is incorporated herein by reference in its entirety for all purposes.

### TECHNICAL FIELD

The technical field generally relates to Volume Bragg Gratings and more particularly concerns a method of manufacturing a Volume Bragg Grating in a cylindrical bulk medium using a rotating technique.

### BACKGROUND

It is known in the art to manufacture Volume Bragg gratings (VBGs) in either bulk glass pieces, or optical fibers of much larger dimension than optical fibers hosting Fiber Bragg Gratings (FBGs). Classical FBGs are typically written in sections of optical fibers having a diameter of 5 to 50 μm, whereas VBGs address sections of up to a few millimeters in diameter. VBGs may for example be used as pulse stretchers, laser pump stabilizers or reflector, beam combiners and splitters, and the like.

Commercially available VBGs are usually made in photo-thermo-refractive (PTR) glass, using a holographic method in which the full volume of the glass is exposed all at once to the refractive index pattern writing the grating. A large volume of material is exposed and then cut to a final size having a square section of 3 to 5 mm width and a length of 3 to 7 cm. This method however requires specialty glasses of complex composition. Additionally, the resulting VBGs can suffer from propagation losses, limiting the maximum optical power that can go through the component.

It is also known in the art to manufacture VBGs by femtosecond inscription using non-linear processes. Referring to FIG. 1 (PRIOR ART), a typical set up to write VBGs using femtosecond laser pulses is illustrated (see for example Voigtlander et al “Inscription of high contrast volume Bragg gratings in fused silica with femtosecond laser pulses”, Appl Phys A (2011) 102:35-38). A femtosecond laser beam from a suitable light source is focussed, using a cylindrical lens, in a rectangular block of fused silica glass through a phase mask. The interference of the −1 and +1 orders of diffraction of the femtosecond laser beam in close proximity to the phase mask generates a diffraction pattern, which is photoinduced in the block, through non-linear interactions of the femtosecond pulses with the glass material at the focus of the laser beam. Since the region where the inscription takes place is very small, scanning techniques over three axes are used to move the laser beam focus within the rectangular block. The inscription of a large VBG under these conditions is challenging, since the beam parameters of the femtosecond laser beam need to be maintained in order to optimize the non-linear interaction across the writing region. In the illustrated example from Voigtlander, the phase mask and the substrate are fixed together and translated with respect to the laser beam. One drawback of this method is that the writing of a structure large enough for typical VBG applications can be quite time consuming.

There remains therefore a need for a method to produce VBGs having a higher power handling and better overall performance and design flexibility.

### SUMMARY

In accordance with one aspect, there is provided a method of manufacturing a Volume Bragg Grating (VBG), comprising the steps of:
a) providing a cylindrical bulk medium made of a transparent glass material and having a central axis along a longitudinal direction;
b) inscribing an interference pattern in the cylindrical bulk medium, the interference pattern comprising a plurality of grating fringe elements distributed along a line parallel to the central axis;
c) rotating the cylindrical bulk medium about the central axis during said inscribing, thereby azimuthally extending the grating fringes elements.

In some implementations, the glass material of the cylindrical bulk medium is one of fused silica doped with germanium, pure silica, hydrogen loaded glass, deuterium loaded glass or a combination thereof.

In some implementations, the cylindrical bulk medium has a length greater than about 1 millimeter, and preferably between about 3 cm and about 7 cm. In some implementations, the cylindrical bulk medium has a diameter between about 50 μm and about 10 mm, preferably between about 3 mm and about 10 mm, and more preferably between about 100 μm and about 600 μm.

In some implementations, the cylindrical bulk medium is a glass rod or a large core or a large cladding of an optical fiber. Alternatively, the cylindrical bulk medium may comprise a hollow core.

In some implementations, the inscribing of step b) uses a femtosecond non-linear process, and preferably comprises:
i. generating a writing light beam using a femtosecond laser source;
ii. diffracting the writing light beam using a phase mask, thereby generating said interference pattern;
iii. focussing the light beam onto a writing region of the cylindrical bulk medium.

The rotating of the cylindrical bulk medium of step c) may be performed in a continuous or a step by step fashion.

In some implementations, the method further comprises a step of:
d) moving the interference pattern radially with respect to the central axis of the cylindrical bulk medium.

In some implementations, the rotating of the cylindrical bulk medium of step c) comprises performing at least one full rotation of the cylindrical bulk medium, thereby extending the grating fringe elements into grating fringe rings. The method may further comprise a step of d) moving the interference pattern radially with respect to the central axis of the cylindrical bulk medium and repeating steps b) and c), thereby extending the grating fringe rings into radially extending grating fringe bands. Optionally, step d) may be repeated one or more times.

In some implementations, the method may comprise moving the interference pattern radially with respect to the central axis concurrently to the rotating of step c) to extend the grating fringe elements into spiral-shaped fringes.

In some implementations, the method may comprise moving the interference pattern longitudinally concurrently to the rotating of step c) to extend the grating fringe elements into coil-shaped fringes.

In some implementations, the method may comprise moving the interference pattern concurrently to the rotating of step c) according to a cycle extending the grating fringe elements into slanted fringes.

In some implementations, the method may comprise moving the interference pattern concurrently to the rotating of step c) according to a cycle extending the grating fringe elements into conical fringes.

In some implementations, the method may comprise repeating steps b) and c) at one or more different longitudinal positions along the cylindrical bulk medium.

In some implementations, the inscribing of step b) comprises making multiple passes on one or more location in the cylindrical bulk medium.

In some implementations, the cylindrical bulk medium is secured on a rotating chuck having a rotation axis, the central axis of the cylindrical bulk medium being aligned with the rotation axis of the rotating chuck. The method may then comprise:
measuring, in real time, a longitudinal error on an instant position of the cylindrical bulk medium during the rotation of step c); and
moving the grating pattern in the longitudinal direction as a function of the measured error to follow the longitudinal movement of the cylindrical bulk medium during said rotation.

The measuring of the longitudinal error on an instant position of the cylindrical bulk medium may include using an optical interferometer comprising a mirror affixed to an end of the rotating chuck opposite the cylindrical bulk medium, or using a displacement sensor positioned at an end of the cylindrical bulk medium opposite the rotating chuck.

In some implementations, the method comprises:
predetermining a synchronous longitudinal error on an instant position of the cylindrical bulk medium during the rotation of step c); and
moving the grating pattern in the longitudinal direction as a function of the predetermined synchronous error to follow the longitudinal movement of the cylindrical bulk medium during said rotation.

In accordance with another aspect, there is provided the use of a VBG manufactured according the method of any one of the implementations above as a compressor of a Chirped Pulsed Amplification system.

In accordance with another aspect, there is provided the use of a VBG manufactured according the method of any one of the implementations above as a pump reflector of a cladding-pumped fiber laser.

In accordance with another aspect, there is provided the use of a VBG manufactured according the method of any one of the implementations above as a pump stabilizer of a cladding-pumped fiber laser.

In accordance with another aspect, there is provided the use of a VBG manufactured according the method of any one of the implementations above as a beam splitter.

In accordance with another aspect, there is provided the use of a VBG manufactured according the method of any one of the implementations above as a beam combiner.

In accordance with another aspect, there is provided a Volume Bragg Grating (VBG), comprising:
a cylindrical bulk medium made of a transparent glass material and having a central axis along a longitudinal direction;
an interference pattern inscribed in the cylindrical bulk medium by rotation about the central axis, the interference pattern comprising a plurality of grating fringe elements distributed along a line parallel to the central axis and azimuthally extending, at least partially, about the central axis.

In some implementations, the glass material of the cylindrical bulk medium is one of fused silica doped with germanium, pure silica, hydrogen loaded glass, deuterium loaded glass or a combination thereof.

In some implementations, the cylindrical bulk medium has a length greater than 1 millimeter and preferably between about 3 cm and about 7 cm.

In some implementations, the cylindrical bulk medium has a diameter between about 50 μm and about 10 mm, preferably between about 3 mm and about 10 mm, and more preferably between about 100 μm and about 600 μm.

In some implementations, the cylindrical bulk medium is a glass rod, a large core or a large cladding of an optical fiber, or may comprise a hollow core.

In some implementations, the grating fringe elements form a non-uniform fringe profile within a radial plane across the cylindrical bulk medium.

In some implementations, the interference pattern having a continuous axial symmetry with respect to the central axis.

In some implementations, the grating fringe elements form grating fringe rings, or grating fringe bands extending in a radial plane across the cylindrical bulk medium. The grating fringe bands may be uniform. Alternatively, the grating fringe elements form spiral-shaped fringes, coil-shaped fringes, slanted fringes or conical fringes.

In accordance with another aspect, there is provided a Chirped Pulse Amplification system, comprising:
a pulse stretcher;
an amplifier; and
a pulse compressor comprising a VBG hosted in a cylindrical bulk medium made of a transparent glass material and having a central axis along a longitudinal direction, the VBG comprising an interference pattern inscribed in the cylindrical bulk medium by rotation about the centra axis, the interference pattern comprising a plurality of uniform grating fringe bands extending in a radial plane across the cylindrical bulk medium and distributed along a line parallel to the central axis.

In some implementations, the glass material of the cylindrical bulk medium is one of fused silica doped with germanium, pure silica, hydrogen loaded glass, deuterium loaded glass or a combination thereof.

In some implementations, the cylindrical bulk medium has a length greater than 1 millimeter and preferably between about 3 cm and about 7 cm.

In some implementations, the cylindrical bulk medium has a diameter between about 50 μm and about 10 mm, preferably between about 3 mm and about 10 mm, and more preferably between about 100 μm and about 600 μm.

In some implementations, the cylindrical bulk medium is a glass rod, a large core or a large cladding of an optical fiber, or may comprise a hollow core.

In some implementations, the interference pattern has a continuous axial symmetry with respect to the central axis.

In some implementations, uniform grating fringe bands of the VBG have a diameter substantially equal or smaller to a diameter of the cylindrical bulk medium.

In some implementations, the pulse stretcher comprises a VBG hosted in a cylindrical bulk medium.

In accordance with another aspect, there is provided a Chirped Pulse Amplification system for amplifying optical pulses, comprising:
a pulse stretcher comprising an optical fiber provided with a Fiber Bragg grating (FBG) having a dispersion profile designed to stretch each of the optical pulses into stretched optical pulses;
an amplifier receiving and amplifying the stretched optical pulses into amplified stretched optical pulses; and
a compressor provided downstream the amplifier for compressing the amplified stretched optical pulses into amplified compressed optical pulses, the compressor comprising a VBG hosted in a cylindrical bulk medium made of a transparent glass material and having a central axis along a longitudinal direction, the VBG comprising an interference pattern inscribed in the cylindrical bulk medium by rotation about the central axis, the interference pattern comprising a plurality of uniform grating fringe bands extending in a radial plane across the cylindrical bulk medium and distributed along a line parallel to the central axis.

In some implementations, the glass material of the cylindrical bulk medium is one of fused silica doped with germanium, pure silica, hydrogen loaded glass, deuterium loaded glass or a combination thereof.

In some implementations, the cylindrical bulk medium has a length greater than 1 millimeter and preferably between about 3 cm and about 7 cm.

In some implementations, the cylindrical bulk medium has a diameter between about 50 μm and about 10 mm, preferably between about 3 mm and about 10 mm, and more preferably between about 100 μm and about 600 μm.

In some implementations, the cylindrical bulk medium is a glass rod, a large core or a large cladding of an optical fiber, or may comprise a hollow core.

In some implementations, the interference pattern has a continuous axial symmetry with respect to the central axis.

In some implementations, uniform grating fringe bands of the VBG have a diameter substantially equal or smaller to a diameter of the cylindrical bulk medium.

In some implementations, the pulse stretcher comprises a VBG hosted in a cylindrical bulk medium.

In accordance with another aspect, there is provided a cladding-pumped fiber laser, comprising:
a laser cavity comprising a length of active optical fiber defining an active gain region configured to generate a laser beam;
a pump diode generating a pump beam coupled into one or more cladding modes of the active optical fiber for absorption by the active gain region; and
a pump reflector provided downstream the active gain region so as to reflect an unabsorbed residual portion of the pump beam back into the active gain region, the pump reflector comprising a VBG hosted in a cylindrical bulk medium made of a transparent glass material and having a central axis along a longitudinal direction, the VBG comprising an interference pattern inscribed in the cylindrical bulk medium by rotation about the central axis, the interference pattern comprising a plurality of grating fringe elements distributed along a line parallel to the central axis and azimuthally extending about the central axis, the VBG having reflectivity characteristics providing a reflection of the unabsorbed residual portion of the pump beam while allowing the generated laser beam through.

In some implementations, the laser cavity comprises a high-reflectivity fiber Bragg grating, and a low-reflectivity fiber Bragg grating provided on either side of the active gain region. The pump reflector may be provided downstream the low-reflectivity fiber Bragg grating.

In some implementations, the glass material of the cylindrical bulk medium is one of fused silica doped with germanium, pure silica, hydrogen loaded glass, deuterium loaded glass or a combination thereof.

In some implementations, the cylindrical pump medium consists of a double clad optical fiber having a central core configured to guide the laser beam and a multimode cladding configured to guide the pump light beam and hosting said VBG. The central core mat have a diameter between about 6 μm and about 50 μm, and the multimode cladding may have a diameter between about 125 μm and about 1000 μm.

In some implementations, the interference pattern has a continuous axial symmetry with respect to the central axis.

In some implementations, the grating fringe elements form grating fringe rings, or grating fringe bands extending in a radial plane across the cylindrical bulk medium. The grating fringe bands may be uniform. Alternatively, the grating fringe elements form spiral-shaped fringes, coil-shaped fringes, slanted fringes or conical fringes.

In accordance with another aspect, there is provided a cladding-pumped fiber laser, comprising:
a laser cavity comprising a length of active optical fiber defining an active gain region configured to generate a laser beam;
a pump diode generating a pump beam coupled into one or more cladding modes of the active optical fiber for absorption by the active gain region; and
a pump stabilizer comprising VBG provided between the pump diode and the length of active optical fiber and configured to reflect a portion of the pump beam back into the pump diode, the VBG being hosted in a cylindrical bulk medium made of a transparent glass material and having a central axis along a longitudinal direction, the VBG comprising an interference pattern inscribed in the cylindrical bulk medium by rotation about the central axis, the interference pattern comprising a plurality of grating fringe elements distributed along a line parallel to the central axis and azimuthally extending about the central axis.

In some implementations, the glass material of the cylindrical bulk medium is one of fused silica doped with germanium, pure silica, hydrogen loaded glass, deuterium loaded glass or a combination thereof.

In some implementations, the cylindrical pump medium may consist of a large core optical fiber. The core of the large core optical fiber may have a diameter between about 50 μm and about 1 mm.

In some implementations, the interference pattern has a continuous axial symmetry with respect to the central axis.

In some implementations, the grating fringe elements form grating fringe rings, or grating fringe bands extending in a radial plane across the cylindrical bulk medium. The grating fringe bands may be uniform. Alternatively, the grating fringe elements form spiral-shaped fringes, coil-shaped fringes, slanted fringes or conical fringes.

Other features of the invention will be better understood upon reading of embodiments thereof with reference to the appended drawings.

### BRIEF DESCRIPTION OF THE DRAWINGS

FIG. 1 (PRIOR ART) is a schematic illustration of a system for writing a VBG in a rectangular bulk medium according to prior art.

FIG. 2 is a perspective view of a cylindrical bulk medium for hosting a VBG according to one embodiment.

FIGS. 3A and 3B are top and side views of a system to write a VBG according to one implementation; FIG. 3C is an enlarged portion of the system of FIG. 3A.

FIGS. 4A and 4B are an end view of a cylindrical bulk medium during the VBG writing process according to one embodiment; FIGS. 4C and 4D are perspective and side views of a VBG defining circular fringe bands resulting from the writing process of FIGS. 4A and 4B.

FIG. 5A illustrates the writing of a VBG defining a spiral-shaped fringe pattern according to one embodiment. FIGS. 5B, 5C and 5D are respectively an end view, a side view and a perspective view of a VBG defining a helical coil-shaped fringe pattern according to one embodiment.

FIGS. 6A and 6B are perspective and side views of a VBG forming slanted fringe planes according to one variant.

FIGS. 7A and 7B are perspective and side views of a VBG forming conical fringes according to one variant.

FIGS. 8A and 8B illustrate the longitudinal extension of a VBG in a cylindrical bulk medium according to one embodiment.

FIG. 9A is a schematic representation of the writing VBG in a cylindrical bulk medium illustrating the fringe washing phenomenon. FIG. 9B schematically illustrates the compensation in real time of the longitudinal movement of the cylindrical bulk medium during its rotation.

FIGS. 10A and 10B schematically illustrate the use of a position feedback mechanism configured to measure the longitudinal error and correct the alignment of the grating pattern in real time during the writing of a VBG according to one embodiment.

FIG. 11 is a schematic illustration of a CPA system using a VBG hosted in a cylindrical bulk medium according to one implementation.

FIG. 12 is a schematic illustration of a cladding-pumped fiber laser using a VBG hosted in a cylindrical bulk medium as a pump reflector according to one implementation.

FIG. 13 is a schematic illustration of a cladding-pumped fiber laser using a VBG hosted in a cylindrical bulk medium as a pump stabiliser according to one implementation.

### DETAILED DESCRIPTION

In accordance with one aspect, there is provided a method for manufacturing a Volume Bragg Grating (VBG). A system for manufacturing a VBG and a VBG having improved characteristics are also provided.

To provide a more concise description, some of the quantitative expressions given herein may be qualified with the term “about”. It is understood that whether the term “about” is used explicitly or not, every quantity given herein is meant to refer to an actual given value, and it is also meant to refer to the approximation to such given value that would reasonably be inferred based on the ordinary skill in the art, including approximations due to the experimental and/or measurement conditions for such given value.

In the present description, the term “about” means within an acceptable error range for the particular value as determined by one of ordinary skill in the art, which will depend in part on how the value is measured or determined, i.e., the limitations of the measurement system. It is commonly accepted that a 10% precision measure is acceptable and encompasses the term “about”.

In the present description, when a broad range of numerical values is provided, any possible narrower range within the boundaries of the broader range is also contemplated. For example, if a broad range value of from 0 to 1000 is provided, any narrower range between 0 and 1000 is also contemplated. If a broad range value of from 0 to 1 is mentioned, any narrower range between 0 and 1, i.e., with decimal value, is also contemplated.

The expression “Bragg grating” is understood by those skilled in the art as referring to a periodic or aperiodic refractive index pattern permanently provided in a medium. The refractive index pattern has a spatial profile designed to transmit and/or reflect light propagating in the medium as a function of the light wavelength and angle of incidence.

A VBG is a Bragg grating provided in a volume of bulk medium made of glass or other transparent materials. The expression VBG may be used in the art to designate both the grating structure photoinduced inside the bulk medium, or the volume of material provided with such a grating structure. VBGs are typically understood by those skilled in the art as structures of a scale larger than Fiber Bragg Gratings (FBGs), for which the Bragg Grating is typically provided along the core of an optical fiber. VBGs may also be referred to in the art as bulk Bragg Gratings or volume phase gratings.

VBGs may for example be used as pulse stretchers in Chirped Pulse Amplification (CPA) systems and the like, laser pump stabilizers, laser pump reflectors, beam combiners, beam splitters, and the like.

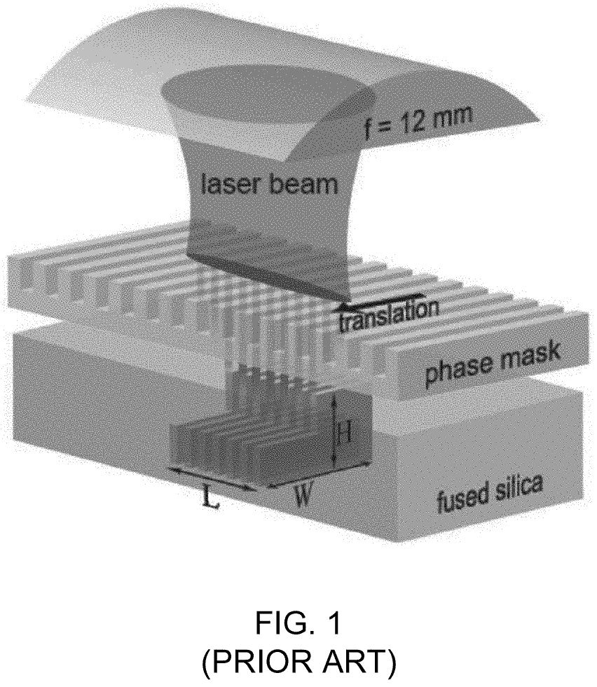

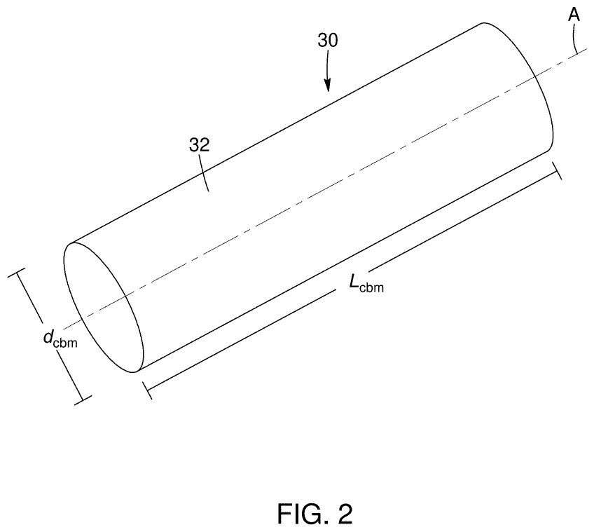

Typically, VBGs are manufactured in blocks of glass or other materials having a square or rectangular cross-section, using systems such as shown in FIG. 1 (PRIOR ART) moving the writing beam along two orthogonal directions. This approach leads to a grating geometry which is also rectangular. In applications wherein a laser beam of circular cross-section is to be guided within the VBG without its spatial distribution being affected, providing a grating geometry matching that of the beam may improve the beam characteristics of the light outputted by the VBG. Referring to FIG. 2, in accordance with one aspect, the present method of manufacturing a VBG includes providing a cylindrical bulk medium 30. As will be explained further below, the use of a cylindrical bulk medium to host the VBG can facilitate the inscription of VBGs of azimuthal geometries.

The cylindrical bulk medium 30 has an outer wall 32, a length L_{cbm} and a diameter d_{cbm}. A central axis A may be defined along the longitudinal direction of the cylindrical bulk medium 30. In some implementations, the length L_{cbm} of the cylindrical bulk medium may be greater than about 1 millimeter, for example from a few millimeters up to about 20 cm or more. In some embodiments, the length L_{cbm} of the cylindrical bulk medium is between about 3 cm and about 10 cm, and preferably between about 3 cm and about 7 cm. The diameter d_{cbm} of the cylindrical bulk medium may be between about 50 μm and about 10 mm, and may be dependent on the intended use of the VBG. By way of example, for typical CPA applications the diameter d_{cbm} of the cylindrical bulk medium may be between about 3 mm and about 10 mm. In another example, for typical pump reflector applications the diameter d_{cbm} of the cylindrical pump medium may be between about 100 μm and about 600 μm, or up to about 1 mm. In some implementations, the cylindrical bulk medium 30 may be a large core or a large cladding of an optical fiber. In other implementations, the cylindrical bulk medium may be a glass rod.

In some implementations, the bulk medium in which the VBGs described herein are provided may be a glass material. In one implementation, the glass material may be fused silica doped with germanium, similarly to the core of typical optical fibers used for telecommunications applications, as germanium doping is known in the art to improve the photosensitivity of the glass. In other embodiments, the glass material may be pure silica, hydrogen loaded glass, deuterium loaded glass or combinations of all of the above. The use of other glass compositions may also be envisioned, preferably with a view to compositions having properties minimizing optical losses, accelerating the writing process or both, depending on the requirements of a particular implementation. As will be readily understood by one skilled the art, the material of the cylindrical bulk medium is preferably of sufficient quality such that absorption losses of light propagating in the VBG is minimized, thereby reducing heat buildup that could generate thermal lensing effects and degrade the beam. It will be further understood that the composition of the glass material may vary within the cylindrical bulk medium. For examples, embodiments involving a large optical fiber as the cylindrical bulk medium will have a different composition within the core and the cladding of the fiber. In other implementations, the cylindrical bulk medium may have a hollow core so as to define a tubular shape, the VBG being inscribed in the material surrounding the hollow core.

The method further includes a step of inscribing a Bragg grating in the cylindrical bulk medium.

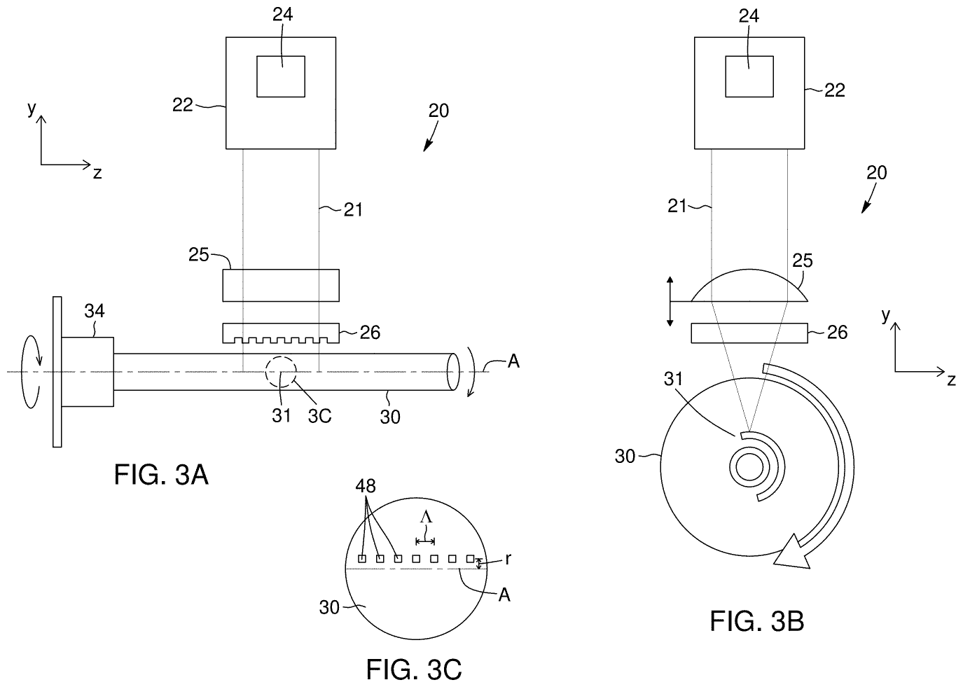

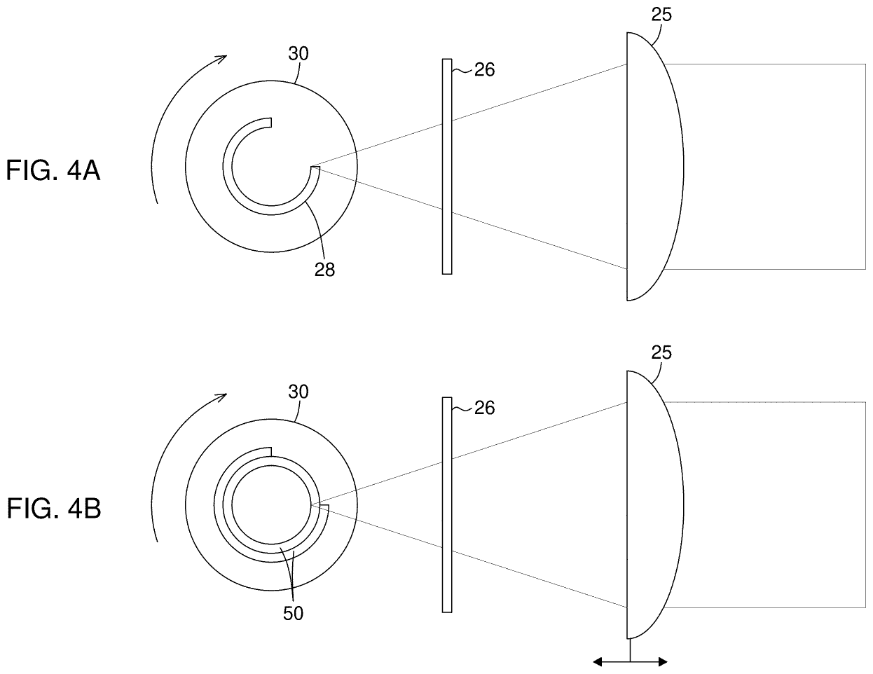

In some implementations, the inscription is performed using femtosecond non-linear processes. Referring to FIGS. 3A and 3B, there is shown an example of an optical system 20 which may be used to inscribe a Bragg grating in the cylindrical bulk medium 30 according to embodiments of the present method.

The optical system 20 includes a light generator 22 for generating a writing light beam 21 of ultrafast optical pulses. By “ultrafast”, it is understood that the duration of the optical pulses is in the femtosecond range, preferably between about 1 femtosecond and about 2 picoseconds, or between about 10 and about 1000 femtoseconds, or between about 20 and about 100 femtoseconds. The energy of the femtosecond pulses is preferably selected to provide the desired intensity in the glass material of the optical fiber, that is energy by duration by surface area (typically measured in W/cm²). In some implementations, the pulse energy maybe of the order of a nanojoule, a microjoule or a millijoule. The repetition rate of these optical pulses may for example be set between about 1 Hz and about 10000 Hz, or between about 1 kHz and about 5 kHz. As one skilled in the art will readily understand, at low repetition rate, for example less than about 1 Hz, the writing process requires a longer exposure time to reach a target reflectivity of the Bragg grating, which may lead to mechanical instabilities and therefore limit the growth of the grating. The use of a high repetition rate (i.e., above 250 kHz) enables a shorter exposure time to reach the same target reflectivity but may also lead to a local detrimental heating effect that would limit the grating growth. The repetition rate of the optical pulses is therefore preferably set to an appropriate value within the range above in order to avoid the detrimental effects of both extremes. It will however be understood that this range is given by way of information only and that different implementations may involve different repetition rates without departing from the scope of the invention.

The writing light beam 21 is preferably characterized by a writing wavelength or wavelengths selected to enable the desired writing process upon interaction with the material of the cylindrical bulk medium 30. This selection preferably takes under consideration the optical properties of the material of the cylindrical bulk medium 30. It is known in the art that ultrafast light pulses in a glass material can lead to a permanent refractive index change in the material through glass densification. The non-linear interaction of the ultrafast light pulses with the glass matrix can also lead to defects such as the formation of color centers or the formation of damaged micro-structures, which may contribute to the change in the refractive index but also may lead to absorption and/or diffusion losses. It will be readily understood that one or more of these phenomena may be present in various embodiments of the method described herein without departing from the scope of the present invention. Suitable wavelengths known in the art for example include 266 nm, 400 nm, 522 nm, 800 nm and 1045 nm.

The light generator 22 preferably includes a femtosecond laser source 24. In some embodiments, the light generator 22 may involve components for the nonlinear conversion of the light pulses generated by the femtosecond light source through second harmonic generation or optical parametric processes. In one example, the femtosecond light source 24 may be embodied by a Ti-sapphire laser emitting the light beam of optical pulses 21 at about 800 nm and of pulse duration of about 35 fs, with an energy per pulse of the order of 200 μJ. Operating the same laser to emit pulses of a duration in the range of 30 to 50 fs (repetition rate of 1 to 5 kHz) can provide from about 150 to 300 μJ per impulsion. In another example, the femtosecond light source 24 may be embodied by an ytterbium-doped fiber laser emitting the light beam of optical pulses 21 at about 1045 nm and of pulse duration of about 250 fs. In some embodiments the light generator 22 may include a nonlinear conversion device 50 converting the ultrafast optical pulses 21 of the aforementioned laser sources through second or higher harmonic generation or optical parametric processes. For example, converting 800 nm pulses into 400 nm pulses can provide about 50-200 μJ per pulse of about 50-100 fs duration, at a repetition rate of about 1 to 5 kHz. 1040 nm pulses can also be converted into 520 nm pulses.

One skilled in the art will readily understand that other techniques than femtosecond inscription may alternatively be used to write the grating pattern. In some examples, if the material of the cylindrical bulk medium has photosensitive properties, a UV writing beam may be used.

The light generator module 22 and/or the optical system 20 may include one or more additional optical components to shape, redirect focus, collimate, modulate or otherwise affect the writing light beam such as mirrors, lenses, spatial phase modulator, amplitude modulator and the like.

Still referring to FIGS. 3A and 3B, the optical system 20 further includes a focussing lens 25 and a phase mask 26, disposed between the light generator 22 and the cylindrical bulk medium 30. The focussing lens 25 focusses the writing light beam 21 onto a writing region 31 within the cylindrical bulk medium 30. In some implementations, the focussing lens may be a cylindrical or acylindrical lens.

The expression “phase mask” is generally understood by one skilled in the art as referring to a surface-relief structure forming corrugations in a material substantially transparent at the writing wavelength. The corrugations define a diffraction grating having parameters selected such that the writing light beam 21 is diffracted by the phase mask to form the interference pattern defining the Bragg grating. The phase mask 26 may for example be made of silica and may be fabricated according to any appropriate technique as well known in the art.

The phase mask 26 is characterised by a pitch corresponding to the period of its corrugations. The pitch of the phase mask is selected according to the target wavelength of the Bragg grating. To obtain a Bragg grating resonance at a design target wavelength λ_{B}, the periodic modulation of the effective refractive index in the grating region of the cylindrical bulk medium must respect the phase-matching condition given by:

$$\frac{2 \cdot n \cdot π}{Λ} = 2 \cdot \frac{2 π \cdot {n}_{eff}}{{λ}_{B}} \qquad ( 1 )$$

where n_{eff} is the effective refractive index of the medium at the grating region, Λ is the period of the interference pattern at the grating region and n=1, 2, 3 . . . is the diffraction order. By simplification, we obtain:

$${λ}_{B} = 2 \cdot {n}_{eff} \cdot \frac{Λ}{n} \qquad ( 2 )$$

The design wavelength λ_{B} corresponds to the fundamental Bragg resonance for n=1. In some embodiments, the phase mask has a pitch providing the fundamental Bragg resonance as the target wavelength. In other embodiments, the pitch of the phase mask may be selected to provide a high order resonance (n=2, 3, . . . ) at the target wavelength of the Bragg grating.

In other variants (not shown), the interference pattern of the writing beam 20 maybe generated without the use of a phase mask. For example, in some variants the more classical two beam interferometer method, the point by point method (See A. Martinez, M. Dubov, I. Khrushchev and I. Bennion, “Direct writing of fibre Bragg gratings by femtosecond laser”, Electronics Letters 40(19):1170-1172, October 2004, incorporated herein by reference in its entirety) or the plane by plane method (see Lu, Ping & Mihailov, Stephen & Ding, Hanjie & Grobnic, Dan & Walker, Robert & Coulas, David & Hnatovsky, Cyril & Naumov, Andrei. (2018) “Plane-by-Plane Inscription of Grating Structures in Optical Fibers” Journal of Lightwave Technology. PP. 1-1. 10.1109/JLT.2017.2750490, incorporated herein by reference in its entirety) may be used.

The interference pattern obtained through diffraction of the writing light beam 21 by the phase mask 26 and impinged on the grating region of the cylindrical bulk medium 30 results in a modification of the refractive index of the glass in a permanent fashion, as explained above, therefore providing the desired Bragg grating. Referring to FIG. 3C, this modification is typically spatially limited to a line of grating fringe element 48 parallel to the central axis A of the cylindrical bulk medium 30, at a radial distance r from the central axis A, and longitudinally separated by the grating period A. Each grating fringe element 48 corresponds to a fringe of the interference pattern, which is transferred from the writing light beam 21 to the glass of the cylindrical bulk medium 30. The dimensions of each grating fringe element 48 correspond to the spatial extend of the femtosecond filament interacting with the material of the cylindrical bulk medium 30 to modify its refractive index, and may have a shape approximated to as a small rectangular filament having a length (L) in the radial direction of the cylindrical bulk medium which depends on the depth over which the refractive index modification occurs at the focus of the writing beam, and a width (w) in the longitudinal direction and a thickness (t) in a tangential direction. By convention, the radial distance r is measured from the center of the length L of a given grating fringe element 48 to the center axis A. By way of example, for typical femtosecond non-linear processes the length L which may be of the order of a few micrometers to a few tens of micrometers, the width w is a fraction of the grating period A which is typically less than a micrometer, whereas the thickness t may be of the order of a few micrometers. Although FIG. 3C schematically illustrates the grating fringe elements 48 as squares, in some embodiments, the thickness of the grating fringe elements 48 may be small enough compared to their length so they appear to be linear shaped.

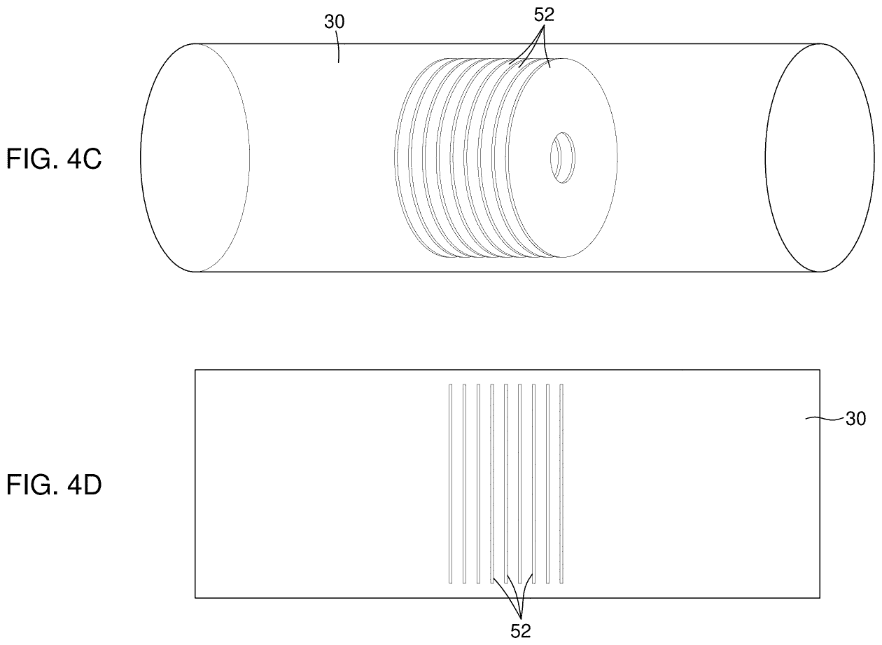

With additional reference to FIGS. 4A and 4B, the present method further includes a step of rotating the cylindrical bulk medium 30 about the central axis A of the cylindrical bulk medium 30 during the inscription process. In some implementations the rotating of the cylindrical medium is performed in a continuous fashion, whereas in other implementations it is performed in a step by step fashion. As will be readily understood by one skilled in the art, rotating the cylindrical bulk medium 30 results in the photoinducing of the grating pattern at different angular positions around the center axis A of the cylindrical bulk medium 30 at a same distant r from the center axis A, thereby azimuthally extending the grating fringe elements 48. In one implementation, at least one 360 degrees rotation of the cylindrical bulk medium 30 is continuously performed, so that each grating fringe element 48 is extended into a grating fringe ring 50 of radius r. Each grating fringe ring 50 has a thickness corresponding to the length L in the radial direction of the corresponding grating fringe elements 48.

Referring back to FIG. 3A, in one implementation the system 20 may include a rotating chuck 34 on which is secured an extremity of the cylindrical bulk medium 30. The cylindrical bulk medium is mounted with its central axis A precisely centered on the rotation axis of the rotating chuck 34.

Referring to FIGS. 4A and 4B, in some implementations, multiple concentric grating fringe rings 50 may be photoinduced into the cylindrical bulk medium 30. In such variants, the method preferably further includes a step of moving the focus of the writing light beam radially with respect to the central axis A of the cylindrical bulk medium 30. The focus may be moved following each complete turn to form another grating fringe ring 50 of a different radius. Preferably, adjacent grating fringe rings 50 may be contiguous or may have a slight overlap in the radial direction (as illustrated in an exaggerated fashion in FIG. 4B), to provide a uniform refractive index modification in the radial direction. With additional reference to FIGS. 4C and 4D, in some variants the resulting VBG may be a longitudinal succession of circular fringe bands 52 each extending radially across the cylindrical bulk medium 30, and longitudinally spaced apart by a distance corresponding to the grating period A.

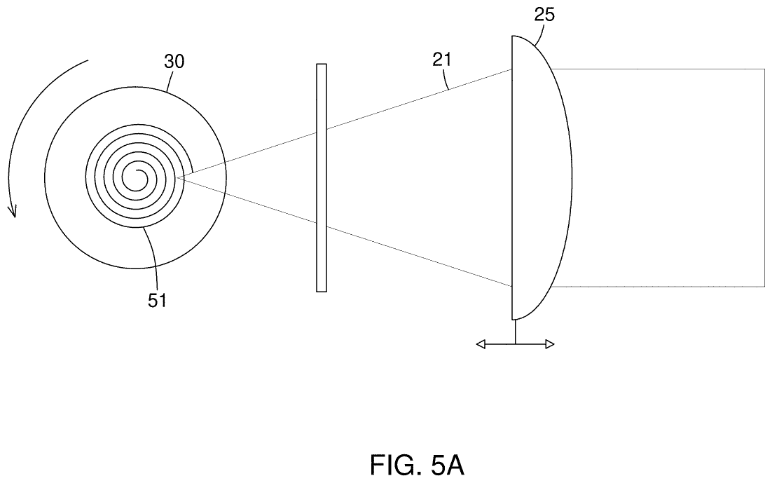

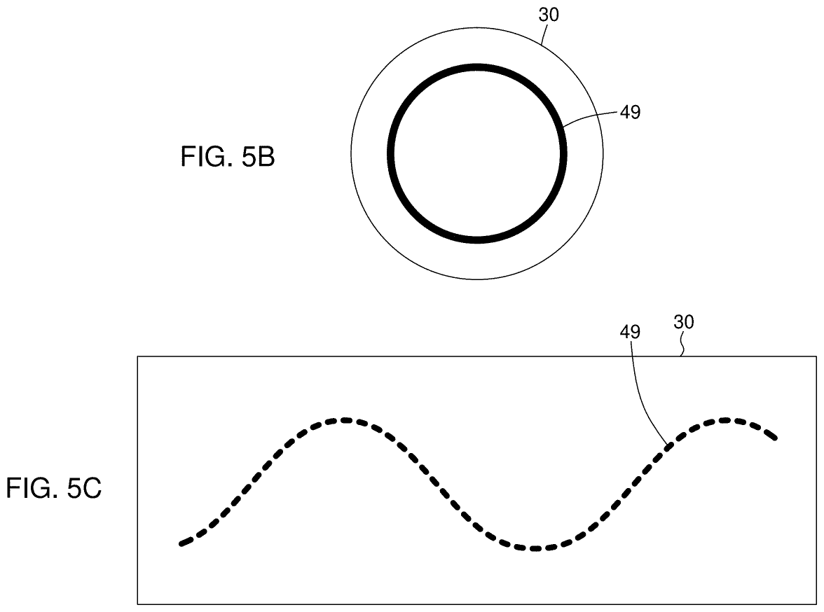

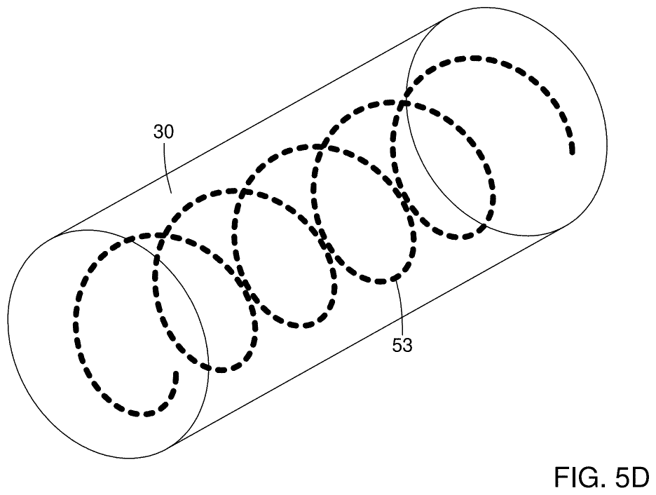

It will be readily understood that the VBG photoinduced in the cylindrical bulk medium 30 using the method described herein may have a different geometry than the grating fringe rings and/or circular fringe bands described above. In some implementations, such as illustrated in FIG. 5A, the focus of the writing light beam 21 may be moved radially in a continuous fashion concurrently to the rotation of the cylindrical bulk medium 30, resulting in a form a spiral-shaped fringe pattern 51. In some implementations, this may be accomplished by moving the position of the focussing lens 25, for example using a translation stage, or using a beam shaper in the path of the writing beam. Referring to FIGS. 5B, 5C and 5D, in one implementation the writing beam or the cylindrical bulk medium may be translated longitudinally (in the direction of axis A) during the writing process, resulting in a coil-shaped fringe pattern 49. Both the variants of FIGS. 5A and 5B to 5D may be combined to obtain a more complex fringe pattern.

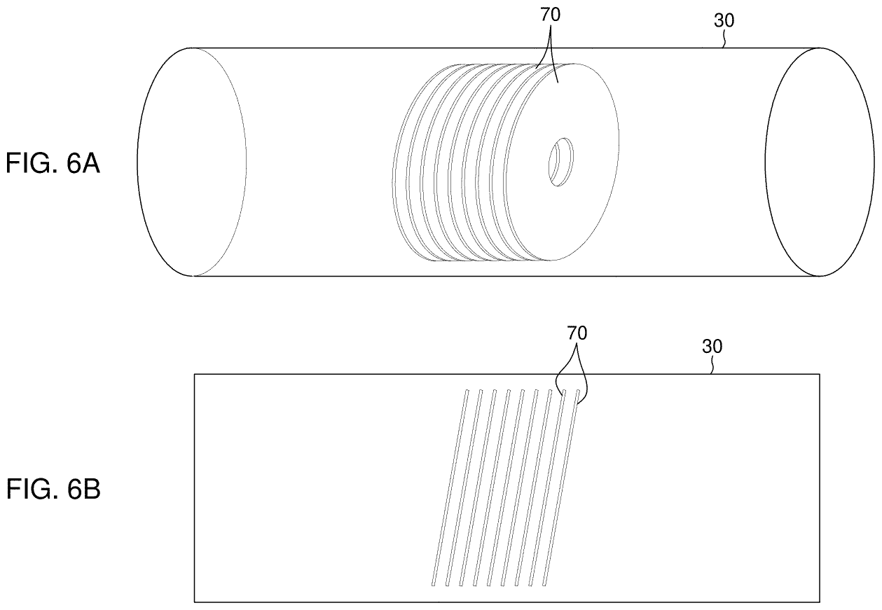

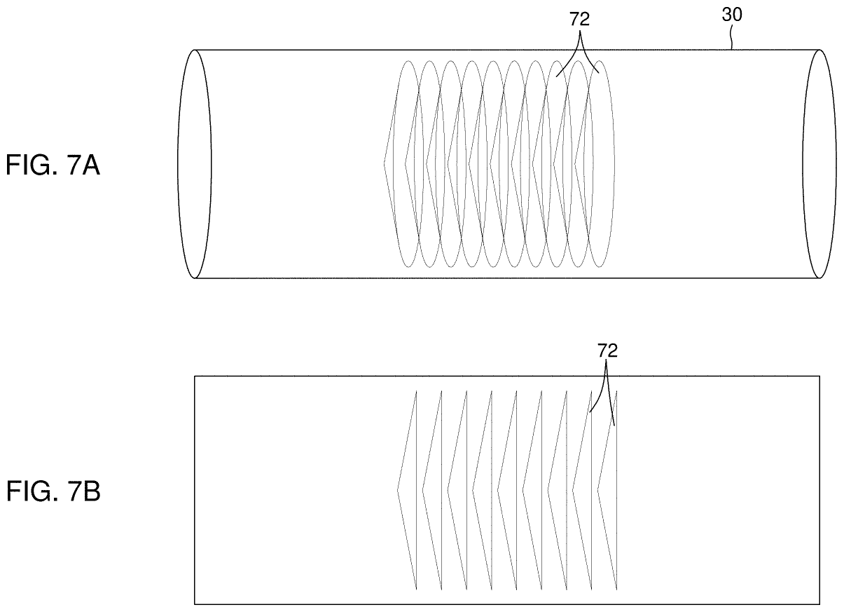

It will be understood by one skilled in the art that other fringe configurations may be envisioned. By way of example, in other embodiment of the invention, the interference pattern may be shifted in a predetermined manner during the rotation of the cylindrical bulk medium 30 in order to produce slanted fringes 70 (see FIGS. 6A and 6B) or conical fringes 72 (see FIGS. 7A and 7B) or other specific fringe patterns. Furthermore, in some implementations a chirped phase mask can be used to produce a chirped VBG, as known in the art.

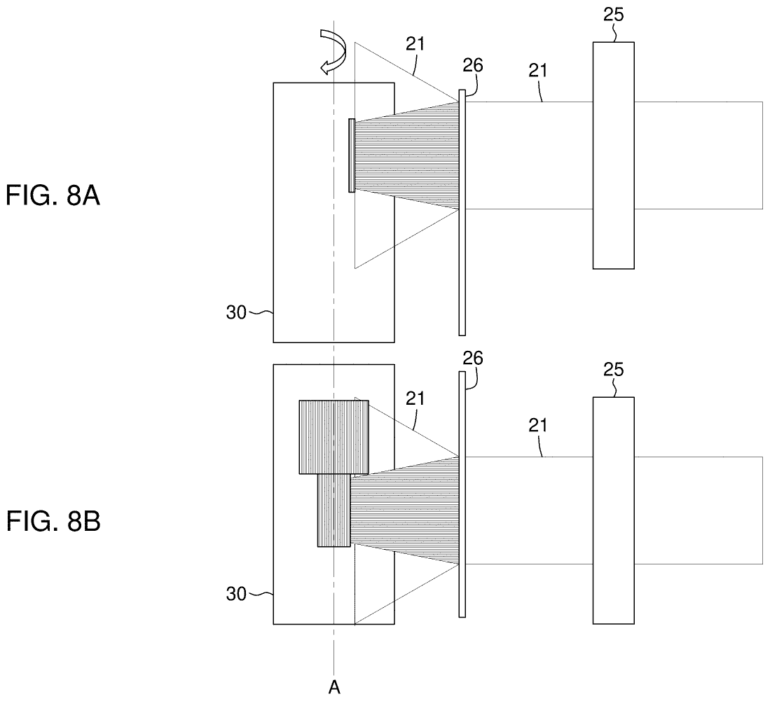

In some variants, longer Bragg gratings may be obtained by repeating the writing process above at different longitudinal positions along the cylindrical bulk medium 30. This may for example include longitudinally displacing the cylindrical bulk medium 30, the focus of the writing beam 21 or both between each writing sequence the longitudinal displacement may be performed concurrently to the rotation of the cylindrical bulk medium 30 and radial movement of the writing beam, or between consecutive radial writing sequences. FIGS. 8A and 8B illustrate one variant in which the cylindrical bulk medium and the phase mask remain in a fixed position with respect to each other, and the writing beam is translated parallelly to the longitudinal direction of the cylindrical bulk medium, along the phase mask. In this manner, the interference pattern imposed on the writing beam by the phase mask remains “locked” on the cylindrical bulk medium.

Alternatively, the beam can be positioned in such a way that the focus does not have to be moved radially while maintaining azimuthal uniformity provided by the rotation of the rod. Such a variant may for example be used if the length L of the grating fringe elements is sufficient to provide the desired radial extend across the cylindrical bulk medium.

In any of the variants above, multiple passes may be made at any given location in the cylindrical bulk medium in order to obtain the desired strength of the local refractive index change.

In some implementations, the system is configured to compensate for fringe “washing” of the Bragg Grating pattern which may be induced by the rotation of the cylindrical bulk medium.

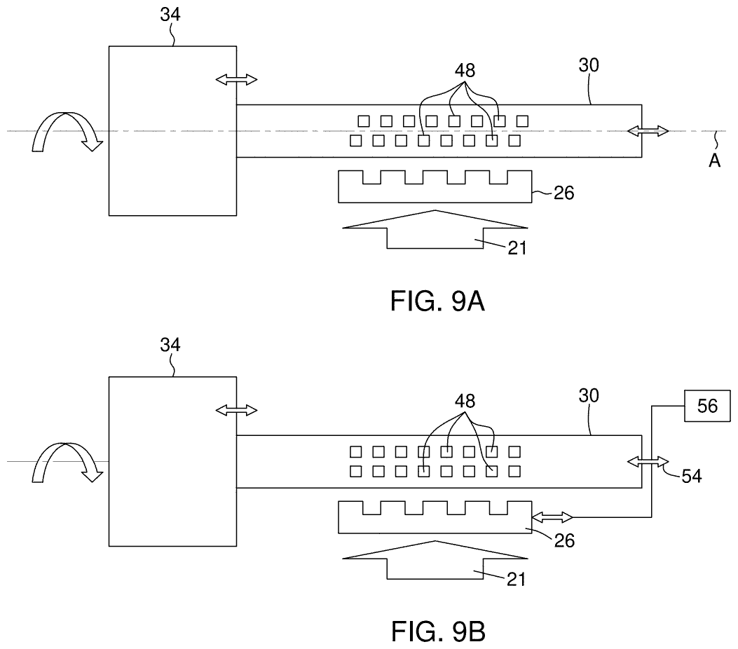

The fringe washing phenomenon is illustrated in FIG. 9A. In some implementations, as the cylindrical bulk medium 30 is rotated about axis A, small movements or vibrations of the rotating chuck 34 may lead to small longitudinal variations in the location of the fringe element 48 at different radial or azimuthal positions around the central axis A. This longitudinal offset of the grating pattern can reduce the fringe visibility. This phenomenon can also be observed if the grating process involves more than one pass of the writing beam at a given location.

Referring to FIG. 9B, in accordance with one aspect, the present method includes a step of compensating in real time for the longitudinal movement of the cylindrical bulk medium 30 during its rotation. This step involves maintaining a same longitudinal alignment of the grating pattern of the writing beam along the central axis A of the cylindrical bulk medium 30 despite longitudinal displacements of the cylindrical bulk medium 30 during its rotation.

As is know in the art, mechanical factors such as imbalances of a rotating system and the quality and precision of bearings and other components of such systems can lead to small displacements of the rotating component along the rotation axis. This longitudinal displacement can have two components: a synchronous component, repeatable at each rotation, and an asynchronous component which is random. While the synchronous component can be characterized in advance and systematically compensated, the asynchronous needs to be measured in real-time.

In some variants, the present method includes measuring a longitudinal error 54 on the position of the cylindrical bulk medium 30 during its rotation, and moving the grating pattern of the writing beam 21 in the longitudinal direction as a function of the measured error 54, to follow the longitudinal movement of the cylindrical bulk medium 30 as it rotates.

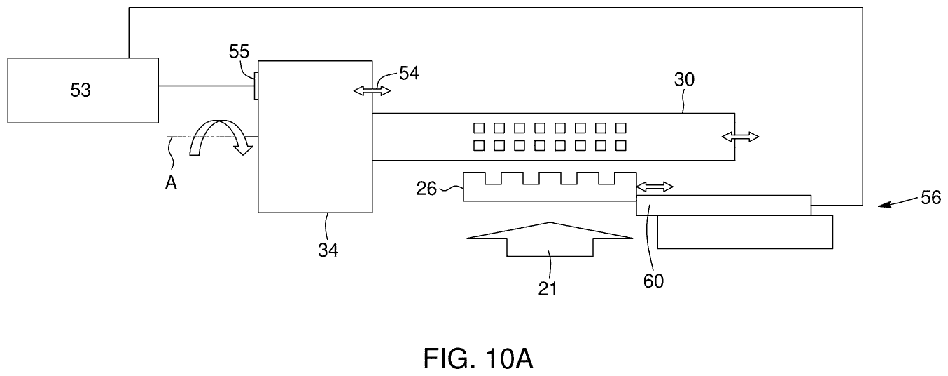

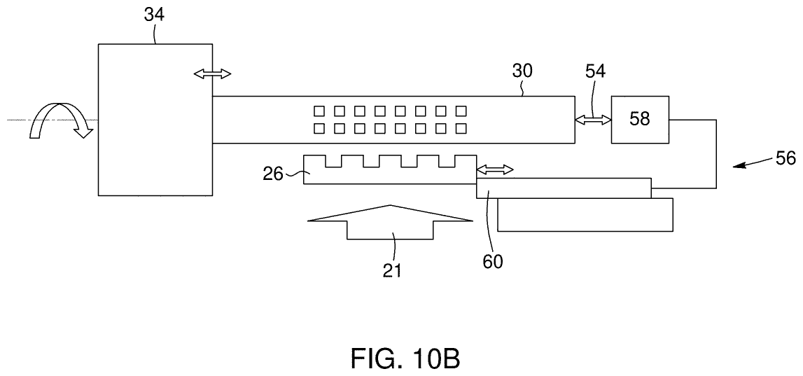

In some implementations, the system 20 may include a position feedback mechanism 56 configured to measure the longitudinal error 54 and correct the alignment of the grating pattern in real time. The longitudinal error 54 may be measured at either end of the bulk cylindrical medium 30. Referring to FIG. 10A, in some variants the system 20 may include an optical interferometer 53 measuring the longitudinal error 54 from the reflection on a mirror 55 affixed to an end of the rotating chuck 34 opposite the cylindrical bulk medium 54, and properly aligned. In other variants, such as shown in FIG. 10B, a capacitive sensor 58 or any other small displacement sensor in the nanometer range may be used to measure the longitudinal error 54 from the displacement of the end of the cylindrical bulk medium 30 opposite the rotating chuck 34. The measurement preferably takes into account that the rotation may also cause small angular deviations of the central axis A, which may impact the accuracy of the measurement of the longitudinal displacement. In some implementations, the angular deviations may be small enough so that the impact on the fringe visibility is not significant. As shown in both FIGS. 10A and 10B, the system 20 further includes a translation stage 60, controllable in real time, to which the phase mask 26 is secured. The measured longitudinal error 54 is used as input to generate a control signal to the translation stage 60 and move the phase mask to match 26 the longitudinal movements of the bulk cylindrical medium 30 as it rotates. In other variants, other optical components may be moved to displace the grating pattern in conjunction with the longitudinal error 54. For example, in the point-by-point technique the writing beam may be moved to track the longitudinal movement of the cylindrical bulk medium by moving a focusing lens.

Advantageously by using a position feedback mechanism 56 as described above, the movement of the writing beam 21 intrinsically compensates for both the synchronous and asynchronous components of the longitudinal error 54.

In some variants, if the asynchronous component of the longitudinal error 54 is small enough, the method and system above may only compensate the synchronous longitudinal error. In such an embodiment the real-time measurement of the longitudinal error may be omitted, and the system 20 may be precalibrated to move the writing beam 21 to compensate for the synchronous component of the longitudinal error having been evaluated or characterized in advance.

VBGs as described above or fabricated using the method and/or system described above may be used in a variety of contexts. In some implementations, such VBGs may act as or be integrated in pulse stretchers, laser pump stabilizers, pump reflectors, beam combiners and splitters, and the like. Such VBGs may be particularly advantageous for applications where the light beam circulated in the VBG has a circular symmetry.

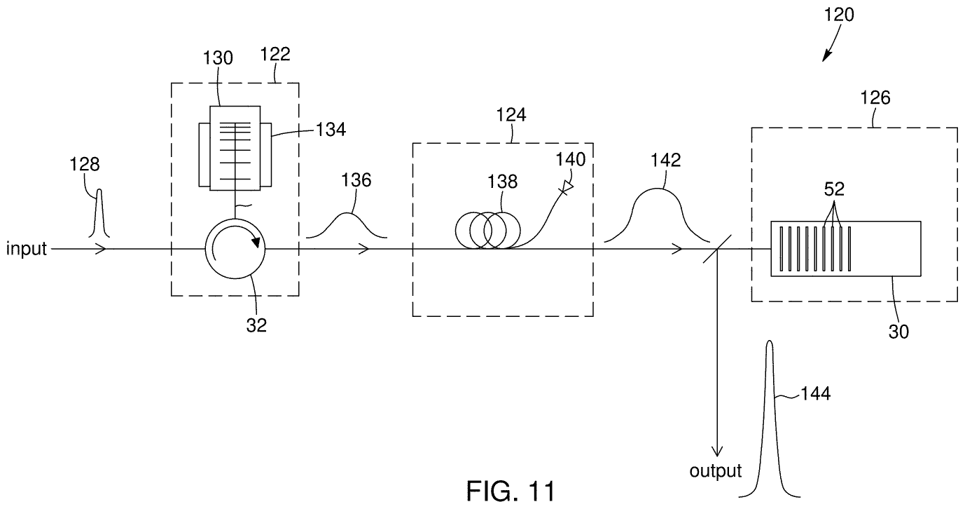

Referring to FIG. 11, there is shown one example of implementation where a cylindrical bulk medium 30 hosting a VBG according to one embodiment is used as part of a compressor 126 of a Chirped Pulse Amplifications system (CPA) 120.

CPA systems such as described herein may be useful in a variety of applications. Examples of applications of CPA systems include micromachining (e.g., fuel injectors, battery electrodes cutting), ophthalmology, lab-on-a-chip, semiconductor dicing, stents manufacturing, internal engraving of transparent material, etc.

In some implementations, the CPA system 120 includes three major modules or components: a fiber pulse stretcher 122, an amplifier 124 and the compressor 126.

The CPA system 120 is configured to receive as input a light beam including one or more laser pulses, referred to herein as the input optical pulses 128. A single pulse 128 is illustrated on FIG. 8 by way of example only. It will be readily understood that the input light beam may include a single pulse or a plurality of pulses, and that the use of the singular or plural in the present description is not meant as a limitation to the scope of application. The input optical pulses 128 may be generated from any one of a variety of oscillators or laser devices such as bulk, fiber-based or semiconductor-based mode-locked lasers, as well known in the art. The input optical pulses 128 are coupled to the CPA system 20 through any suitable direct or indirect coupling scheme, such as for example a fiber splice between respective optical fibers on both sides.

The pulse stretcher 122 includes a fiber Bragg grating (FBG) 30. The FBG 130 has a dispersion profile designed to stretch each of the optical pulses 128 into time-spread spectral components, such that each input optical pulse 128 is spread into a longer pulse of similar energy, defining a stretched optical pulse 136.

In some implementations, the FBG may be designed by referring to dispersive characteristics of other components of the CPA system (fibers, amplifier and compressor) to determine its dispersion profile, for example using transfer matrix methods to calculate the response of the Bragg grating. The FBG may then be written according to this design. In some implementations, the writing of the FBG involves the use of a phase mask, optionally using methods such as for example described in the U.S. Pat. No. 6,501,883. Residual dispersion profile errors may then be mitigated using a post correction method such as for example described in U.S. Pat. No. 7,142,292. Once the FBG is integrated to the CPA system, final adjustments can be made using the tuning mechanism described hereinafter.

In the illustrated configuration, the pulse stretcher 122 includes a circulator 132 directing the input optical pulses 128 towards the FBG 130, and then receiving and directing the reflected stretched optical pulses 136 from the FBG 130 towards the amplifier 124. It will be readily understood by one skilled in the art that other configurations may be envisioned. Preferably, the pulse stretcher 122 is entirely fiber-based. The pulse stretcher 122 may further include a tuning mechanism 134 coupled to the FBG 130 for tuning its dispersion profile. As known in the art, the wavelength of peak reflection for a Bragg grating can be shifted by a change in either the strain or the temperature (or both) imposed on the grating. If the optical fiber 131 hosting the Bragg grating 130 is subject to a strain or temperature gradient, the modulation period of the index of refraction pattern and the mean index of refraction can be modified with the goal of fine-tuning the dispersion characteristic of the grating. The tuning mechanism 134 may therefore include an assembly changing the strain applied to the optical fiber 131 hosting the FBG, an assembly applying a temperature gradient to this optical fiber 131, or a combination of both.

In some implementations, the tuning mechanism 134 may be configured to apply a strain or temperature variation which is non-uniform along the grating, that is, locally changing the temperature or strain along different portions of the grating. As will be readily understood by one skilled in the art, a non-uniform heating or strain induces a chirp in the grating or modifies a pre-existing chirp. Controlling the magnitude of the thermal gradient or strain variation controls the magnitude of the resulting chirp, and thus there is provided a form of local adjustment of the spectral reflectivity of the grating.

It will be readily understood that in some embodiments, the pulse stretcher may include a VBG as described above.

As mentioned above, the CPA system 120 next includes an amplifier 124. The amplifier 124 may be embodied by any light amplification device suitable to increase the intensity of the stretched optical pulses 136. In the illustrated embodiment, the amplifier 124 is a fiber amplifier. The expression “fiber amplifier” is understood to refer to any device wherein an optical fiber is used as a gain medium to amplify light. Typically, the fiber amplifier includes a length of doped optical fiber 138 provided with rare-earth dopants such as erbium, ytterbium or the like. The doped optical fiber 138 is pumped using a pump source 140. The pump light from the pump source 140 may be injected into the doped optical fiber 138 in a copropagating or counter propagating direction with respect to the propagation of the stretched optical pulses 136 being amplified. It will be readily understood that the fiber amplifier 124 may be configured in a variety of manners and may include specialty fibers or components, multiple amplification stages, etc. In other variants, the amplifier 124 may be a non-fiber device and may for example be implemented in various materials and geometries such as a rod, slab, disk, etc.

The fiber amplifier 124 receives and amplifies the stretched optical pulses 136 into amplified stretched optical pulses 142. As the energy of each input optical pulse 128 is spread over the longer stretched optical pulse 136, the instantaneous peak power along the pulse is reduced, allowing its amplification while avoiding or mitigating non-linear effects known to affect pulses having high peak power.

It will be readily understood that the pulse stretcher 122 and fiber amplifier 124 need not be immediately consecutive and that the CPA system 120 may include additional components or devices in-between such as couplers, pre-amplification stages, etc.

The CPA system 120 next includes a pulse compressor 126. The pulse compressor 126 includes a cylindrical bulk medium 30 provided with a VBG such as described above. Preferably, the VBG defines a plurality of circular fringe bands 52 separated by a distance corresponding to the grating period A. It will however be readily understood that the VBG may have a different configuration without departing from the scope of protection.

In some implementations the VBG may be heated with or without a thermal gradient, in order to modify the average refractive index profile along its length and therefore adjust the grating dispersion.

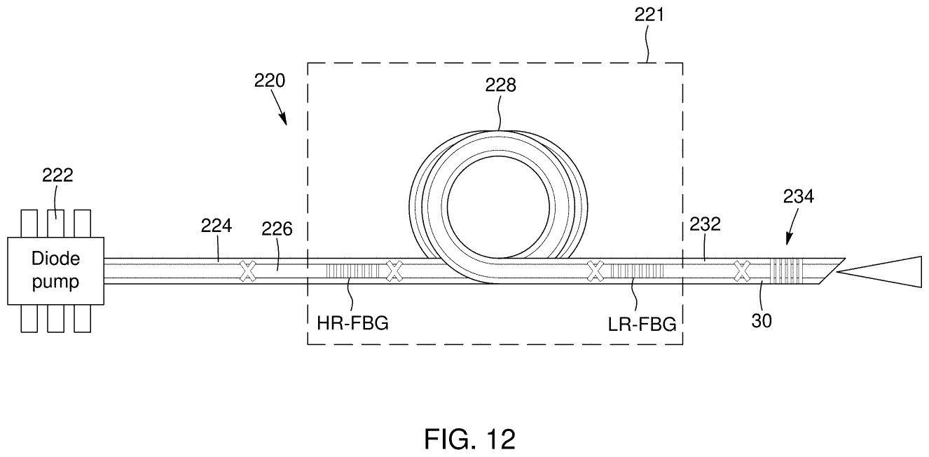

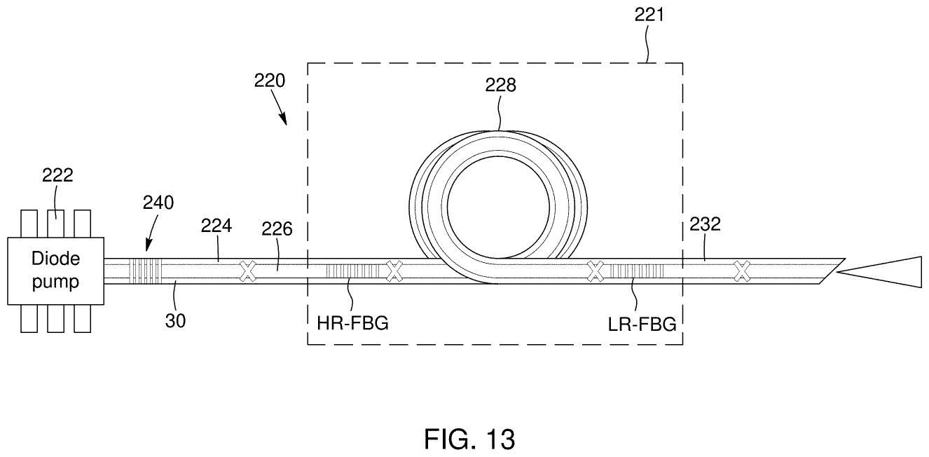

Referring to FIGS. 12 and 13, in accordance with other examples of implementation, there is shown a cladding-pumped fiber laser 220 in which a cylindrical bulk medium 30 hosting a VBG according to one embodiment is used as either a pump reflector (FIG. 12) or a pump stabilizer (FIG. 13).

In both cases, the fiber laser 220 includes a laser cavity 221 having a length of active fiber 228 acting as a gain medium for the light amplification process, that is a gain region configured to generate a laser beam. The active fiber 228 is generally embodied by a rare-earth-doped silica fiber. The laser cavity may be further defined by a high-reflectivity fiber Bragg grating (HR-FBG) and a low-reflectivity fiber Bragg grating (LR-FBG) provided on either side of the gain region. Typically, the HR-FBG and LR-FBG are inscribed in passive optical fibers 226 and 232 spliced to either ends of the length of active fiber 228.

The cladding-pumped fiber laser 220 further includes a pump diode 222 generating a pump beam. Typically, the pump beam is injected into a large core optical fiber 224 spliced to the passive fiber 226 hosting the HR-FBG, so that the pump beam is coupled into numerous cladding modes and travels in the cladding of the fibers of the laser cavity. This approach allows one to easily couple low brightness and highly multimode but very powerful pump light into the cladding of the active fiber. The pump light is then absorbed along the fiber and converted to a core-guided laser signal, with an excellent beam quality and therefore a very large brightness.

Cladding-pumping reduces the pump absorption rate compared to core-pumping schemes, distributing the gain along much longer lengths. This distribution of the pump absorption greatly facilitates the thermal dissipation of the heat generated during such a process. However, laser cavity lengths have to be particularly long to achieve substantial pump absorption. The laser cavity becomes consequently more lossy and expensive, and starts to be sensitive to nonlinear effects, since the fiber length at high power becomes comparable to the characteristic nonlinear length.

Referring in particular to FIG. 12, the above drawbacks may be alleviated by providing a pump reflector 234 downstream the active gain region 228 of the fiber laser cavity, to reflect the residual portion of the pump beam back into the active gain region, therefore increasing the pump absorption. The pump reflector 234 may be embodied by a VBG hosted in a cylindrical bulk medium 30 made of a transparent glass material as described above. The VBG therefore includes an interference pattern inscribed in the cylindrical bulk medium by rotation about the central axis, the interference pattern comprising a plurality of grating fringe elements distributed along a line parallel to the central axis and azimuthally extending about the central axis. The cylindrical bulk medium 30 may be a double-clad fiber having a central core (6-50 micron) configured to guide the laser beam and a larger multimode cladding (125-1000 micron) configured to guide the pump light beam and hosting the VBG. The VBG has reflectivity characteristics providing a reflection of the residual pump light while allowing the generated laser beam through.

It is known in the art that reflecting a portion of a pump beam back in the pump diode of a laser or amplifier system can have the beneficial effect of stabilizing the emission wavelength of the pump diode. Taken alone, diodes naturally emit light across a broad spectral width. Also, due to internal heating in such diodes, their peak wavelength shifts as their output power increases. Those two effects are known to reduce the efficiency of fiber lasers and amplifiers according to the injected pump power, as the rare earth ions dopant of the optically active fibers generally have spectrally narrow absorption cross sections. To circumvent this issue, it is known in the art to provide diodes commonly used to pump fiber systems with an internal wavelength stabilization element, for example a VBG directly mounted into the pump module.

Referring to FIG. 13, in one embodiment the cladding-pumped fiber laser may include a pump stabilizer 240 including a VBG provided between the pump diode 222 and the length of active optical fiber 228 and configured to reflect a portion of the pump beam back into the pump diode 222. The VBG is preferably as described above, that is, is hosted in a cylindrical bulk medium 30 made of a transparent glass material and having a central axis along a longitudinal direction. The VBG includes an interference pattern inscribed in the cylindrical bulk medium 30 by rotation about the central axis, the interference pattern comprising a plurality of grating fringe elements distributed along a line parallel to the central axis and azimuthally extending about the central axis. In one embodiment, the cylindrical bulk medium is embodied by the large core optical fiber 224 spliced to the passive fiber 226 hosting the HR-FBG. In some implementations, the core of the large core optical fiber may have a diameter between about 50 μm and about 400 μm, or up to about 1 mm. In some implementations, the core of the large core optical fiber may have a diameter greater than 100 μm. Typical values of core diameters may for example be about 50 μm, about 100 μm or, in one preferred embodiment, about 200 μm.

Of course, numerous modifications could be made to the embodiments described above without departing from the scope of protection.

1. A method of manufacturing a Volume Bragg Grating (VBG), comprising the steps of:
e) providing a cylindrical bulk medium made of a transparent glass material and having a central axis along a longitudinal direction;
f) inscribing an interference pattern in the cylindrical bulk medium, the interference pattern comprising a plurality of grating fringe elements distributed along a line parallel to the central axis;
g) rotating the cylindrical bulk medium about the central axis during said inscribing, thereby azimuthally extending the grating fringes elements.

2. The method according to claim 1, wherein the glass material of the cylindrical bulk medium is one of fused silica doped with germanium, pure silica, hydrogen loaded glass, deuterium loaded glass or a combination thereof.

3. The method according to claim 1, wherein the cylindrical bulk medium has a length greater than about 1 millimeter.

4. The method according to claim 1, wherein the cylindrical bulk medium has a length between about 3 cm and about 7 cm.

5. The method according to claim 1, wherein the cylindrical bulk medium has a diameter between about 50 μm and about 10 mm.

6. The method according to claim 1, wherein the cylindrical bulk medium has a diameter between about 3 mm and about 10 mm.

7. The method according to claim 1, wherein the cylindrical bulk medium has a diameter between about 100 μm and about 600 μm.

8. The method according to claim 1, wherein the cylindrical bulk medium is a glass rod.

9. The method according to claim 1, wherein the cylindrical bulk medium is a large core or a large cladding of an optical fiber.

10. The method according to claim 1, wherein the cylindrical bulk medium comprises a hollow core.

11. The method according to claim 1, wherein the inscribing of step b) uses a femtosecond non-linear process.

12. The method according to claim 11, wherein the inscribing of step b) comprises:
iv. generating a writing light beam using a femtosecond laser source;
v. diffracting the writing light beam using a phase mask, thereby generating said interference pattern;
vi. focussing the light beam onto a writing region of the cylindrical bulk medium.

13. The method according to claim 1, wherein the rotating of the cylindrical bulk medium of step c) is performed in a continuous fashion.

14. The method according to claim 1, wherein the rotating of the cylindrical bulk medium of step c) is performed in a step by step fashion.

15. The method according to claim 1, further comprising a step of:
h) moving the interference pattern radially with respect to the central axis of the cylindrical bulk medium.

16. The method according to claim 1, wherein the rotating of the cylindrical bulk medium of step c) comprises performing at least one full rotation of the cylindrical bulk medium, thereby extending the grating fringe elements into grating fringe rings.

17. The method according to claim 16, further comprising a step of:
d) moving the interference pattern radially with respect to the central axis of the cylindrical bulk medium and repeating steps b) and c), thereby extending the grating fringe rings into radially extending grating fringe bands.

18. The method according to claim 17, comprising repeating step d) one or more times.

19. The method according to claim 1, comprising moving the interference pattern radially with respect to the central axis concurrently to the rotating of step c) to extend the grating fringe elements into spiral-shaped fringes.

20. The method according to claim 1, comprising moving the interference pattern longitudinally concurrently to the rotating of step c) to extend the grating fringe elements into coil-shaped fringes.

21. The method according to claim 1, comprising moving the interference pattern concurrently to the rotating of step c) according to a cycle extending the grating fringe elements into slanted fringes.

22. The method according to claim 1, comprising moving the interference pattern concurrently to the rotating of step c) according to a cycle extending the grating fringe elements into conical fringes.

23. The method according to claim 1, comprising repeating steps b) and c) at one or more different longitudinal positions along the cylindrical bulk medium.

24. The method according to claim 1, wherein the inscribing of step b) comprises making multiple passes on one or more location in the cylindrical bulk medium.

25. The method according to claim 1, wherein the cylindrical bulk medium is secured on a rotating chuck having a rotation axis, the central axis of the cylindrical bulk medium being aligned with the rotation axis of the rotating chuck.

26. The method according to claim 25, comprising:
measuring, in real time, a longitudinal error on an instant position of the cylindrical bulk medium during the rotation of step c); and
moving the grating pattern in the longitudinal direction as a function of the measured error to follow the longitudinal movement of the cylindrical bulk medium during said rotation.

27. The method according to claim 26, wherein the measuring of the longitudinal error on an instant position of the cylindrical bulk medium comprises using an optical interferometer comprising a mirror affixed to an end of the rotating chuck opposite the cylindrical bulk medium.

28. The method according to claim 26, wherein the measuring of the longitudinal error on an instant position of the cylindrical bulk medium comprises using a displacement sensor positioned at an end of the cylindrical bulk medium opposite the rotating chuck.

29. The method according to claim 1, comprising:
predetermining a synchronous longitudinal error on an instant position of the cylindrical bulk medium during the rotation of step c); and
moving the grating pattern in the longitudinal direction as a function of the predetermined synchronous error to follow the longitudinal movement of the cylindrical bulk medium during said rotation.
